(19) United States
(12) Patent Application Publication
(10) Pub. No.: US 2017/0356479 A1
(43) Pub. Date: Dec. 14, 2017

(54) Locking Cams Assembly and Method

(71) Applicant: Bruce Dominguez, Drexel Hill, PA (US)

(72) Inventor: Bruce Dominguez, Drexel Hill, PA (US)

(21) Appl. No.: 15/618,285

(22) Filed: Jun. 9, 2017

Related U.S. Application Data
(60) Provisional application No. 62/347,782, filed on Jun. 9, 2016.

(51) Int. Cl. F16B 5/02; B25B 13/48; F16B 43/00; F16B 35/00

(52) U.S. Cl. CPC F16B 5/025; F16B 35/005; B25B 13/481; F16B 43/00

(57) ABSTRACT

The assembly solves a frequent problem when aligning one machine to another machine. Typically, the machine to be aligned has very little clearance in the hold-down bolt holes, and running out of adjustment space while aligning is common. This assembly uses cams in enlarged holes in the machine feet. The cams not only allow the machine to be aligned with holes already drilled into a fixed bedplate, but after the machine is set on the bedplate, also allows the machine to be moved more than twice as much as is now permitted. This allows it to be easily aligned with another piece of equipment that is already fixed in place. The assembly also makes dowelling unnecessary, because the cams are locked into place with a set screw to prevent the machine from moving.

### CROSS-REFERENCE TO RELATED APPLICATIONS

This application claims priority to U.S. Provisional Patent Application 62/347,782, filed Jun. 9, 2016, which is hereby incorporated by reference.

### BACKGROUND OF THE INVENTION

The invention relates to the installation of two or more machines where accurate alignment between the machines is critical. When connecting two rotating machines, it is necessary to align them to very accurate tolerances to avoid vibration and wear. The tolerance may be as small as a few thousandths of an inch (hundredths of a millimeter). After alignment, they are doweled in place to prevent movement out of alignment.

Problems arise because the clearances in the hold down bolt holes are sometimes too small to allow the machines to be adjusted for proper alignment. Doweling is time-consuming. A need exists for a doweling-free alignment system with increased tolerances.

### SUMMARY OF THE INVENTION

The invention is an assembly for installing multiple machines and its method of use. In the prior art, the bolt holes in the feet of machines are formed to have only slightly larger diameters than the bolts themselves. This leaves very little tolerance when aligning one machine to another.

In this invention, the bolt holes in the feet of the machines are either manufactured to have a much larger diameter or are enlarged at the installation site. Instead of a single bolt holding the foot, two disk-shaped cams fill the hole and the cams and foot are held in place with a bolt, a large washer, and a set screw. One cam is larger than the other. The larger cam has an opening large enough that the smaller cam fits within it. The smaller cam has an hole with a diameter slightly larger than the bolt. Both cams have at least two pits or holes on top, so that they can be turned with a spanner wrench.

After a first machine is installed, this invention's user sets the second machine on its bedplate. The user aligns the second machine to the first. For each foot of the second machine, the user puts the larger cam into the hole of the foot, then a locating stud through the cam and the hole in the foot into the bolt hole in the bedplate. The user rotates the larger cam to maximize the distance between the locating stud and the sides of the outer cam opening. The user then places the smaller cam onto the larger cam.

The user then rotates the cams until they begin to engage. The Inner Cam will then fit into the Outer Cam. (The user may need to use a modest amount of downward pressure to cause the cams to completely engage with one another.) The user puts the set screw into a hole drilled into the side of the foot. The set screw is inserted far enough within this hole that the set screw engages the edge of the larger cam, locking the cam in position.

The user then removes the locating stud, places the washer in the correct position over the two cams, starts the hold-down bolt into the bedplate, fully tightens the set screw if not already tight enough, and then bolts the assembly into place.
One aspect of the invention is an assembly for bolting a machine to a bedplate comprising:
   an outer cam having an outer cam opening offset from the center of the outer cam;
   an inner cam formed to fit within the outer cam opening, the inner cam having an inner cam opening offset from the center of the inner cam, the bottom of the outer edge of the inner cam being beveled;
   a locating stud;
   a set screw;
   a washer having a diameter greater than the diameter of the outer cam, the top of the inner edge of the washer being beveled, the bottom of the inner edge of the washer being beveled; and
   a bolt.
Another aspect of the invention is the assembly described above, wherein the outer edge of the outer cam has a groove.
Another aspect of the invention is the assembly described in any aspect above, wherein the outer cam has at least two pits on its top side.
Another aspect of the invention is the assembly described in any aspect above, wherein the inner cam has at least two pits on its top side.
Another aspect of the invention is the assembly as described in any aspect above, wherein the bolt hole of the washer is offset from its center.
Another aspect of this invention is a method for installing a second machine to a previously-installed first machine, the second machine comprising:
   at least one machine foot, each machine foot having a machine foot opening; and a bedplate;
      the method comprising:
   setting the second machine on its bedplate so that the machine foot openings in are centered over bedplate bolt holes;
   aligning the second machine to the first machine;
   for each machine foot opening:
      setting an outer cam in the machine foot opening, the outer cam having an outer cam opening offset from the center of the outer cam;
      screwing a locating stud through the machine foot opening and outer cam opening into the bedplate bolt hole;
      rotating the outer cam to maximize the distance between the locating stud and the edge of the outer cam opening;
      placing an inner cam on the outer cam, the inner cam being formed to fit within the outer cam opening, the inner cam having an inner cam opening offset from the center of the inner cam, the bottom of the outer edge of the inner cam being beveled;
      rotating the outer cam and the inner cam until they engage;
      placing downward pressure on the inner cam to insert into the outer cam opening;
      on the side of the machine foot, screwing a set screw into a set screw hole to press the outer edge of the outer cam;
      removing the locating stud from the bolt hole;
      placing a washer over the outer cam and the inner cam, the washer having a diameter greater than the diameter of the outer cam; and
      bolting the washer and the machine foot to the bedplate through the inner cam opening into the bedplate bolt hole.
Another aspect of the invention is the method described above, further comprising:
   for each machine foot, expanding to the machine foot opening so that the outer cam fits within the machine foot opening.
Another aspect of the invention is the method as described in any aspect above, further comprising:
   for each machine foot, drilling a hole into the side of the machine foot running from the side of the machine foot to the machine foot opening.
Another aspect of the invention is the method as described in any aspect above, further comprising:
   after installing the hold-down bolt, further tightening the set screw.
Another aspect of the invention is the method as described in any aspect above, wherein the outer cam has at least two pits on its top side, and wherein the step of rotating the outer cam to maximize the distance between the locating stud and the edge of the outer cam opening comprises turning a spanner wrench whose prongs are within the pits of the outer cam.
Another aspect of the invention is the method as described in any aspect above, wherein the inner cam has at least two pits on its top side, and wherein the step of rotating the outer cam and the inner cam until they engage comprises turning a spanner wrench whose prongs are within the pits of the inner cam.
Another aspect of the invention is the method as described in any aspect above, wherein the pits on the top of the inner cam are drilled and tapped to accommodate a pulling device.
Another aspect of the invention is the method as described in any aspect above, wherein the outer edge of the outer cam has a groove, and wherein the step of screwing a set screw into a set screw hole to press the outer edge of the outer cam comprises engaging the groove of the outer cam.
Another aspect of the invention is the method as described in any aspect above, wherein the pits on the top of the outer cam are drilled and tapped to accommodate a pulling device.

### BRIEF DESCRIPTION OF DRAWINGS

FIG. 1 is an exploded view of a prior art installation of a machine foot.

FIG. 2 is an exploded view of an installation of a machine foot using the present invention.

FIG. 3A is a plan view of the outer cam.

FIG. 3B is a cross-section view of the outer cam.

FIG. 3C is an elevation view of the locating stud.

FIG. 3D is a plan view of the inner cam.

FIG. 3E is a cross-section view of the inner cam.

FIG. 3F is an elevation view of the set screw.

FIG. 3G is a plan view of the hold-down washer.

FIG. 3H is a cross-section view of the hold-down washer.

FIG. 3I is an elevation view of the hold-down bolt.

FIG. 4A is a plan view of a step of the method of installation of the invention.

FIG. 4B is a plan view of a step of the method of installation of the invention.

FIG. 4C is a plan view of a step of the method of installation of the invention.

FIG. 4D is a plan view of a step of the method of installation of the invention.

FIG. 4E is a plan view of a step of the method of installation of the invention.

FIG. 4F is a plan view of a step of the method of installation of the invention.

FIG. 4G is a plan view of a step of the method of installation of the invention.

FIG. 4H is a plan view of a completed installation of the invention.

FIG. 5 is a side elevation view of a completed installation of the invention.

### DETAILED DESCRIPTION OF THE INVENTION

Equipment manufacturers often require that, when two rotating machines are connected, they be positioned within strict limits to avoid vibration and wear. Accurate alignment is necessary because couplings may require alignment to within a few thousandths of an inch (5 hundredths of a millimeter).

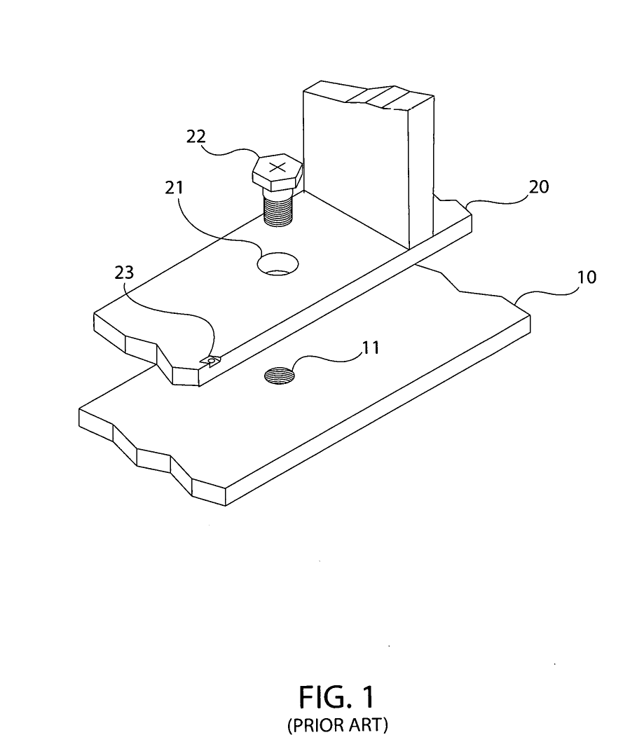

FIG. 1 shows an exploded view of the prior art method of installing a machine to a bedplate. In the prior art, when two or more rotating machines are to be connected, the procedure is:
The bedplates 10 of all the machines are set on the equipment foundation. A bedplate may hold one or multiple machines.
The first bedplate is aligned to the system's external equipment, e.g., piping for a pump, ductwork for an air compressor, or a vent or chimney for a fan.
The other bedplates, if any, are aligned to the first bedplate and each other.
The bedplate(s) are set in concrete.
There are tapped bolt holes in the bedplate(s) which match the bolt holes in the feet of the machine(s). The feet of the first machine are aligned with the holes in its bedplate.
The first machine is set down on the bedplate 10.
The first machine is aligned to the external equipment and bolted in place.
Because of the connections to external equipment, it is rarely possible to move the first machine for further alignment with other machines once it is connected to the external equipment.
Then, the feet of the second machine are aligned with the holes 11 in its bedplate 10.
The second machine is set down on the bedplate 10.
The second machine is aligned to the first machine and bolted in place.
The feet of the second machine are doweled.

In the prior art, the diameters of the bolt holes 21 for the hold-down bolts 22 in the feet 20 of machines are usually ⅜ inch (10 mm) greater than the hold-down bolt 22. With the feet 20 centered on the holes 11 and the hold-down bolt 22 in, the feet 20 may move 3/16 inch (5 mm) parallel to the bedplate 10 in any direction. This can be a problem if the pattern of the holes 11 in the bedplate 10 is not the same as the pattern in the machine feet 20. Additionally when aligning, the machine may need to move more than 3/16 inch (5 mm); this frequently shows up in longer machines, where a small movement at one end is magnified at the other end.

Due to the size of the dowel holes to be drilled, the usual interference of piping and other obstructions, the possible need to drill dowel holes at an angle, doweling a machine foot is a time-consuming process.

In the present invention, an assembly using locking cams locates a machine on a fixed bedplate so that the machine has a greater range of movement and need not be doweled.

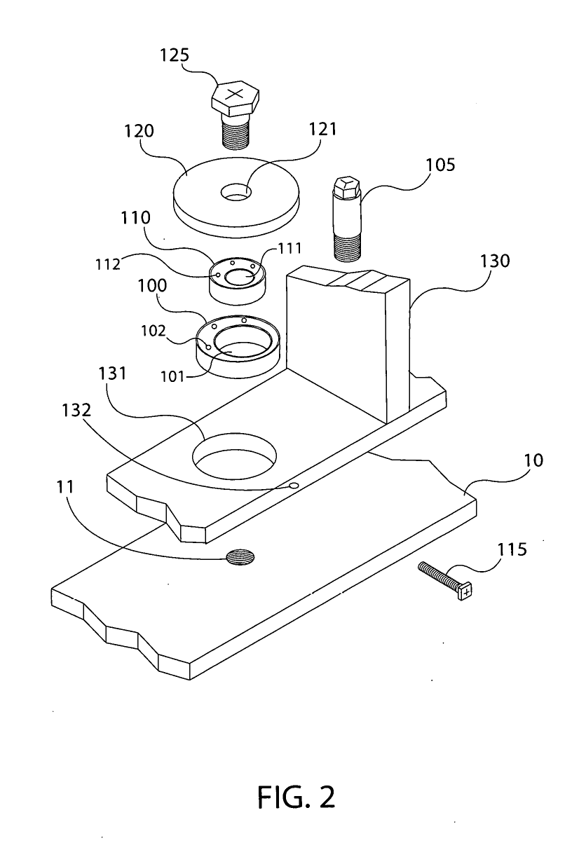

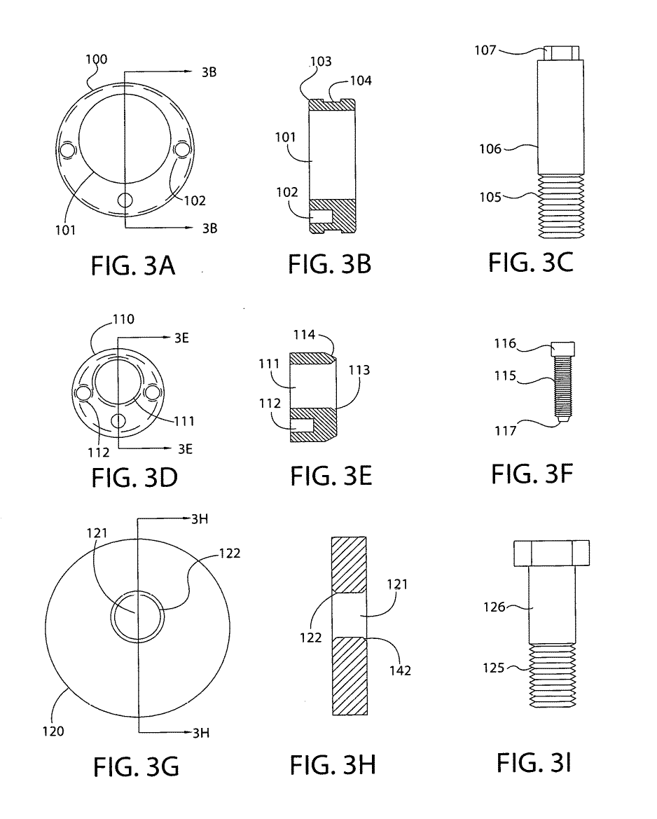

FIG. 2 shows an exploded view of the parts of the assembly. FIG. 3A and 3B show the Outer Cam 100, a stainless steel disc whose diameter is about 0.002 inches (0.05 mm) smaller than the diameter of the foot hole 131. The height of the Outer Cam 100 is about 0.01 inches (0.25 mm) shorter than the machine foot 130, ensuring that the Hold-down Washer 120 sits flush on the machine foot 130. The Outer Cam 100 has a large opening 101 offset from center into which the Inner Cam 110 will be placed.

FIG. 3A shows the Outer Cam 100 from the top down. FIG. 3B shows a cross-section of the Outer Cam 100. Because of the tight clearance, the disc has chamfered corners 103 to allow easier insertion into the foot hole 131. In preferred embodiments, there is a groove 104 in the outer edge of the Outer Cam 100 so that the Set Screw 115 will not damage the surface of the cam perimeter, making it more difficult to remove the Outer Cam 100. In preferred embodiments, the Outer Cam 100 has three holes or pits 102 on the top of the disc to allow the user to use a spanner wrench to rotate the Outer Cam 100. Two of the pits 102 are tapped to allow for the attachment of a pulling device, due to the tight clearances that might make removing the cam difficult. In alternative embodiments, there are no holes or pits on top of the Outer Cam 100.

FIG. 2 also shows the Inner Cam 110, a stainless steel disc whose diameter is about 0.002 inches (0.05 mm) smaller than the large opening 101 in the Outer Cam 100. The Inner Cam 110 has a hole 111 offset from center whose diameter is about 0.002 inches (0.05 mm) greater than the Hold-Down Bolt 125. The height of the Inner Cam 110 is the same as the Outer Cam 100.

FIG. 3D shows the Inner Cam 110 from the top down. FIG. 3E shows a cross-section of the Inner Cam 110. The bottom edge of the hole 111 is beveled 113 to avoid any rough edges of vertical alignment shims around the bolt hole 11, which can prevent the Inner Cam 110 from sitting flat on the shims. The bottom outer edge of the Inner Cam 110 is beveled 114 in order to help seating the Inner Cam 110 into the Outer Cam 100. In preferred embodiments, the Inner Cam has three holes or pits 112 on the top of the disc so that a user can rotate the Inner Cam 110 with a spanner wrench. Two of the pits 112 are tapped to allow for the attachment of a pulling device, due to the tight clearances that might make removing the cam difficult. In alternative embodiments, there are no holes or pits on top of the Inner Cam 110.

FIG. 2 also shows a Locating Stud 105, shown in FIG. 3C from the side. The Locating Stud 105 is the same thread size as the Hold-down Bolt 120. The body 106 of the Locating Stud is longer than the sum of the heights of the foot 130 and the Inner Cam 110. The top 107 of the Locating Stud 105 is formed so that a user may use a wrench to aid removal. The Locating Stud 105 greatly eases establishing the proper position of the Cams 100, 110 around the bedplate hole 11 for the Hold-down Bolt 120. Without the Locating Stud 105, the user would have difficulty determining the position of the Cams 100, 110 where the Hold-Down Bolt 125 fits into the bedplate hole 11.

FIG. 2 shows the Hold-down Washer 120: a steel disc with a height similar to the machine foot 130. The diameter of the Washer 120 is about 1 inch (25 mm) greater than the diameter of the Outer Cam 100. In preferred embodiments, the Washer 120 has a hole 121 offset from center by the same amount as the hole 111 is offset in the Inner Cam 110. In alternative embodiments, the hole 121 is centered in the Washer 120. The hole 121 is the same size as the hole 111 in the Inner Cam 110. To allow a standard bolt to tighten flush on the Washer 120, the top 122 and bottom edges 142 of the hole 121 are beveled. FIG. 3G shows a top-down view of the Washer 120. FIG. 3H shows a cross-section of the Washer 120.

FIG. 3F shows the Set Screw used in FIG. 2. The screw has a square head 116 and a cupped point 117. The size and the length of the Set Screw 115 is determined by manufacturing parameters. The length must allow the Set Screw to completely fill the set screw hole 132 and contact the outer edge or groove 104 of the Outer Cam 100.

Shown in FIG. 2 and FIG. 3I, the size and grade of the Hold-down Bolt 125 is determined by the machine manufacturer. The length of the body 126 of the Bolt 125 is slightly shorter than the combined height of the machine foot 130 and the Hold-down Washer 120. The length of the threaded portion of the Bolt 125 is the either the same height as the bedplate 10 or 1.5 times the diameter of the bolt, whichever is less.

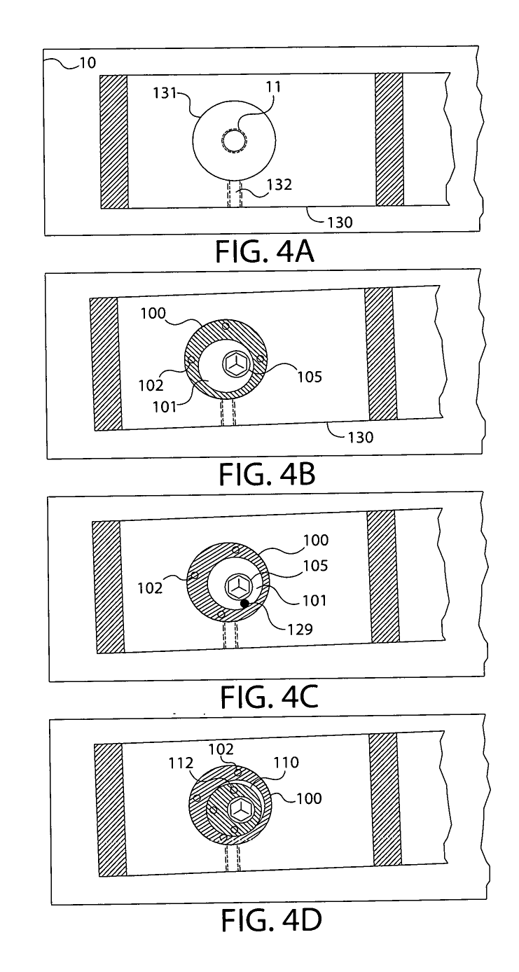

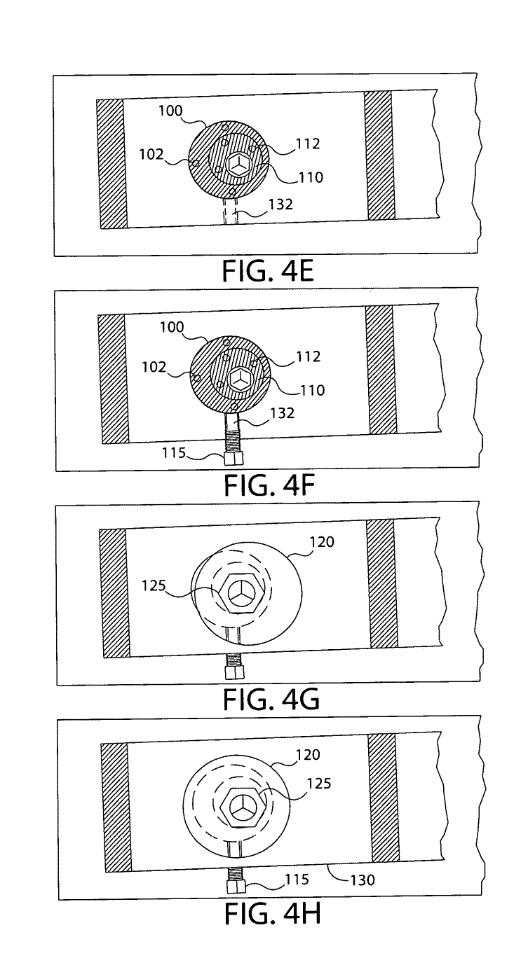

FIGS. 4A-4H show the method of installing machines using this invention. The bedplates 10 of the machines are manufactured and installed, and the first machine is installed, as described above under FIG. 1.

The bolt hole 21 of the original machine foot 20 (see FIG. 1) is enlarged from its original diameter so the new foot 130 has a hole 131 slightly larger than the diameter of the Outer Cam 100. Additionally, a set screw hole 132 is drilled into the side of the foot 130. In preferred embodiments, these will be done by the machine manufacturer itself. In alternative embodiments, this may be done at the installation site. The set screw hole 132 is in line with the centerline of foot hole 131 and runs between the side of the foot 130 and the foot hole 131. The set screw hole 132 is tapped to accept Set Screw 115.

FIG. 4A shows the second machine set on its bedplate 10 with the hole 131 for the Outer Cam 100 in the machine foot 130 centered over the bedplate bolt hole 11. The second machine is then aligned to the first as before, but it now has more possible machine movement for alignment. The machine foot 130 can be moved around the bedplate bolt hole 11 to the limit of the sum of the offsets, greater than the 3/16ths inch allowed in the prior art.

Alignment of two machines usually begins by setting the correct space between coupling centers. The user sets the distance by moving the second machine closer to or further from the first. This adjustment is set first because there is usually much more leeway in this spacing than in the lateral and angular alignment limits, and a slight change in this distance during other adjustments is not critical. The user will usually next adjust the vertical alignment for both the vertical displacement and vertical angular misalignment by adding or subtracting shims to raise or lower the height of the machine. Finally the user will adjust the lateral displacement and lateral angular alignment by shifting the machine sideways. Those skilled in the art will understand when the order of alignment direction should be altered.

FIG. 4B shows one of the second machine's machine feet 130 on the bedplate 10 after the second machine has been aligned to the first.

FIG. 4C shows the machine foot 130 being prepared to be secured. The user places the Outer Cam 100 into the hole 131 of the machine foot 130 and screws the Locating Stud 105 into the bolt hole 11 of the bedplate 10. The Outer Cam 100 is rotated to maximize the gap 129 between the Outer Cam 100 and the Locating Stud 105. This is the only position where the Inner Cam 110, when put on the Locating Stud 105, will fit into the opening 101 of the Outer Cam 100.

In FIG. 4D, the Inner Cam 110 is put on the Locating Stud 105 and slid down to rest on the Outer Cam 100.

FIG. 4E shows, after rotating the Cams 100, 110, the Inner Cam 110 within the opening of the Outer Cam 100. To do this, the Outer Cam 100 can be rotated with a spanner wrench while the Inner Cam 110 usually can be rotated by hand. The Cams 100, 110 are rotated until the beveled outer edge 114 of the Inner Cam 110 enters the opening of the Outer Cam 100. The beveled edge 114 of the Inner Cam 110 acts as a wedge, enabling the Cams 100, 110 to center themselves with some slight downward pressure.

In FIG. 4F, the Set Screw 115 is installed into the hole 132 in the foot 130 and when it is tightened against the outer edge or groove 104 of the Outer Cam 100, the cams 100, 110 are tightened in the foot hole 131.

In FIG. 4G, the user removes the Locating Stud 105, places the Hold-down Washer 120 over the Cams 100, 110, then begins to screw the Hold-down Bolt 125 into the bolt hole 11 of the bedplate 10.

FIG. 4H shows that, before tightening the Hold-down Bolt 125, the Hold-down Washer 120 should be rotated until the eccentric covers the maximum amount of area over the Cams 100, 110 (here shown in dotted lines). The Set Screw 115 is then given a final tightening, if necessary, and the Hold-down Bolt 125 is torqued to its proper value. Due to the tension between the Cams 100, 110 and the Set Screw 115, the machine foot 130 is locked into position and does not need to be doweled. The installation is complete.

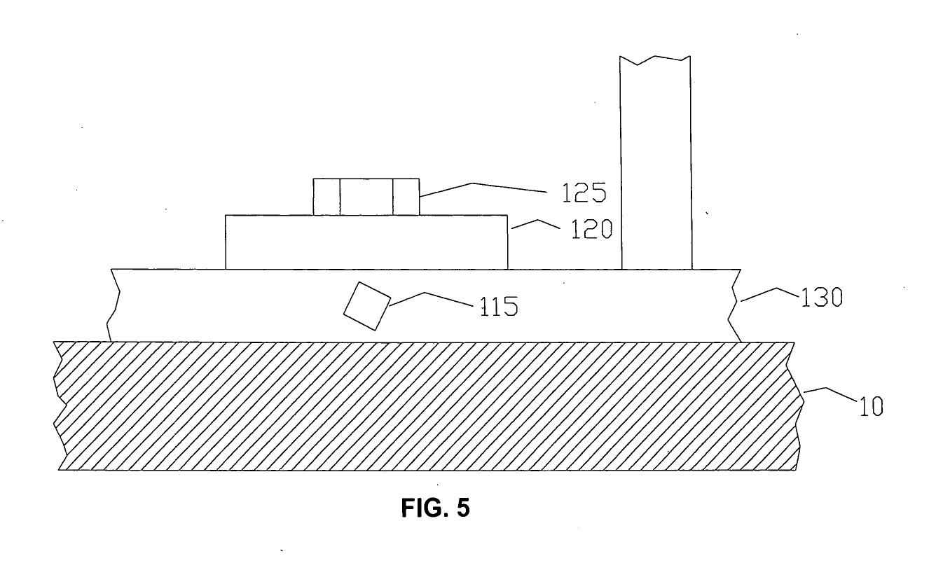

FIG. 5 shows the completed installation from the side of the machine foot 130 where the Set Screw 115 is installed.

Those skilled in the art will understand that measurement equivalents between S.I. and imperial systems are approximate and that when a measurement is given in imperial units, the invention can also operate in the near equivalent measurements in S.I., and vice versa.

1. An assembly for bolting a machine to a bedplate comprising:
an outer cam having an outer cam opening offset from the center of the outer cam;
an inner cam formed to fit within the outer cam opening, the inner cam having an inner cam opening offset from the center of the inner cam, the bottom of the outer edge of the inner cam being beveled;
a locating stud;
a set screw;
a washer having a diameter greater than the diameter of the outer cam, the top of the inner edge of the washer being beveled, the bottom of the inner edge of the washer being beveled; and
a bolt.

2. The assembly of claim 1, wherein the outer edge of the outer cam has a groove.

3. The assembly of claim 2, wherein the outer cam has at least two pits on its top side.

4. The assembly of claim 3, wherein the inner cam has at least two pits on its top side.

5. The assembly of claim 4, wherein the bolt hole of the washer is offset from its center.

6. The assembly of claim 1, wherein the outer cam has at least two pits on its top side.

7. The assembly of claim 6, wherein the inner cam has at least two pits on its top side.

8. The assembly of claim 7, wherein the bolt hole of the washer is offset from its center.

9. A method for installing a second machine to a previously-installed first machine, the second machine comprising:
at least one machine foot, each machine foot having a machine foot opening; and
a bedplate;
the method comprising:
setting the second machine on its bedplate so that the machine foot openings in are centered over bedplate bolt holes;
aligning the second machine to the first machine;
for each machine foot opening:
setting an outer cam in the machine foot opening, the outer cam having an outer cam opening offset from the center of the outer cam;
screwing a locating stud through the machine foot opening and the outer cam opening into the bedplate bolt hole;
rotating the outer cam to maximize the distance between the locating stud and the edge of the outer cam opening;
placing an inner cam on the outer cam, the inner cam being formed to fit within the outer cam opening, the inner cam having an inner cam opening offset from the center of the inner cam, the bottom of the outer edge of the inner cam being beveled;
rotating the outer cam and the inner cam until they engage;
placing downward pressure on the inner cam to insert into the outer cam opening;
on the side of the machine foot, screwing a set screw into a set screw hole to press the outer edge of the outer cam;
removing the locating stud from the bolt hole;
placing a washer over the outer cam and the inner cam, the washer having a diameter greater than the diameter of the outer cam; and
bolting the washer and the machine foot to the bedplate through the inner cam opening into the bedplate bolt hole.

10. The method of claim 9, further comprising:
for each machine foot, expanding to the machine foot opening so that the outer cam fits within the machine foot opening.

11. The method of claim 9, further comprising:
for each machine foot, drilling a hole into the side of the machine foot running from the side of the machine foot to the machine foot opening.

12. The method of claim 9, further comprising:
after installing the hold-down bolt, further tightening the set screw.

13. The method of claim 9, wherein the outer cam has at least two pits on its top side, and wherein the step of rotating the outer cam to maximize the distance between the locating stud and the edge of the outer cam opening comprises turning a spanner wrench whose prongs are within the pits of the outer cam.

14. The method of claim 13, wherein the inner cam has at least two pits on its top side, the pits on the top of the inner cam being drilled and tapped to accommodate a pulling device,
and wherein the step of rotating the outer cam and the inner cam until they engage comprises turning a spanner wrench whose prongs are within the pits of the inner cam.

15. The method of claim 13, wherein the pits on the top of the outer cam are drilled and tapped to accommodate a pulling device.

16. The method of claim 9, wherein the outer edge of the outer cam has a groove, and wherein the step of screwing a set screw into a set screw hole to press the outer edge of the outer cam comprises engaging the groove of the outer cam.
